(19) United States
(12) Patent Application Publication
(10) Pub. No.: US 2018/0154666 A1
(43) Pub. Date: Jun. 7, 2018

(54) TRANSFER MATERIAL FOR SUBLIMATION PRINTING

(71) Applicant: SCHOELLER TECHNOCELL GMBH & CO. KG, Osnabruck (DE)

(72) Inventors: Wolfgang Schmidt, Bad Essen (DE); Sebastian Scholz, Osnabruck (DE); Emanuele Martorana, Hagen (DE)

(21) Appl. No.: 15/576,410

(22) PCT Filed: May 24, 2016
(86) PCT No.: PCT/EP2016/061630

§ 371 Date: Nov. 22, 2017

(30) Foreign Application Priority Data
May 28, 2015 (EP) 15169650.7

(51) Int. Cl. B41M 5/025; B41M 5/035

(52) U.S. Cl. CPC B41M 5/0256; B41M 2205/38; B41M 5/035

(57) ABSTRACT

The invention relates to a transfer material for the dye-sublimation transfer method of an ink jet printing image, comprising a support and an ink receiving layer on the front side of the transfer material, wherein the ink-receiving layer is porous and the transfer material contains a barrier layer which is disposed either on the rear side of the transfer material or between the support and the porous ink-receiving layer.

### TECHNICAL FIELD OF THE INVENTION

The invention relates to a transfer material in the form of a sheet for the dye-sublimation transfer method of an inkjet printed image, comprising a base and a dye-absorbing layer on the front side. The invention therefore relates in particular to a transfer paper which is provided for printing using sublimable dyes by means of the inkjet printing method and from which, after the printing, the dyes can be transferred onto a receiving material by sublimation under the influence of heat. The invention also relates to the transfer method using the transfer material.

### TECHNICAL BACKGROUND OF THE INVENTION

Transfer printing methods in which a flexible transfer material in the form of sheet is first printed on and the printed image is transferred therefrom onto the object to be printed on lend themselves to printing on materials such as textiles or stiff bodies on which, for mechanical reasons, it is hardly possible to print effectively. A specific embodiment for a transfer printing method of this kind is the dye-sublimation method, which is described in B. Thompson: Printing Materials—Science and Technology (1998) on page 468, for example. In this method, the image to be printed is applied to the transfer material using printing dyes which, after the print has dried, are evaporated under the effect of heat and, on the basis of the image, are deposited again in the gas phase on the material to be finally printed on. The sublimation dyes may advantageously be applied to the transfer material by means of digital printing, in particular by means of the inkjet printing method, which makes it possible to produce individual and personalised prints on textiles, for example. Inkjet printing methods using dyes that can be transferred to the final printing carrier by sublimation are disclosed in DE 102 46 209 A1, for example.

The transfer material on which the first printing step is carried out by the inkjet printing technique, is preferably a paper transfer material. EP 1 101 682 A1 describes a coated paper that has a low air permeability on the side to be printed on. This is intended to prevent some of the sublimable dyes from entering the porous interior of the paper during the sublimation transfer step and thus from being lost for the transfer to the material to be finally printed on. However, papers of this kind having a low porosity on the side to be printed on only absorb the inkjet ink liquid very slowly and, in particular at high printing speeds, lead to slow drying and to the ink running on the surface and thus to an unsatisfactory printing sharpness.

EP 2 743 091 A1 describes a transfer material and proposes coating a substrate having low air permeability with a hydrophilic polymer or a salt of a hydrophilic polymer. The coating may also contain an inorganic oxide as a filler in amounts of up to 10 wt. %. Coating solutions of this kind always form a polymer film, which may have gaps when low amounts are applied and coarse base materials are used. Quick absorption and drying of the ink having sublimable dyes, applied by means of the inkjet printing method, is therefore not achieved.

Therefore, US 2008/229962 A1 proposed a coating for a transfer paper containing silica and a comparably low amount of binder and thus having a considerable air permeability. Absorption of the ink liquid is therefore achieved; however, sublimable dye is not prevented from being lost into the interior of the paper during the transfer to the material to be finally printed on.

### SUMMARY OF THE INVENTION

The object of the invention is to provide a transfer paper for the inkjet-printing of sublimable dyes that dries quickly and has a high printing sharpness when aqueous printing inks are used and, at the same time, ensures that the sublimable dyes are largely completely transferred to the material to be finally printed on and is not, or only to a small extent, subject to the sublimable dyes bleeding through to the rear side of the transfer paper.

This object is achieved by a transfer material for the dye-sublimation transfer method of an inkjet printed image, comprising a base and a dye-absorbing layer on the front side of the transfer material, the dye-absorbing layer being porous and the transfer material containing a barrier layer that is arranged either on the rear side of the transfer material or between the base and the porous dye-absorbing layer.

The barrier layer may be arranged either between the porous dye-absorbing layer and the support paper or on the surface of the support paper opposing the dye-absorbing layer.

The invention also relates to a method for transferring an image to a surface in which an image is printed on a transfer material according to the invention by means of the inkjet printing method and the image is transferred to the surface by sublimation.

### DETAILED DESCRIPTION OF THE INVENTION

The transfer papers according to the invention comprise a support paper having a porous dye-absorbing layer applied on the printing side and a barrier layer that is arranged between the dye-absorbing layer and the paper support and/or preferably on the surface of the paper support opposing the dye-absorbing layer.

The support paper is preferably an uncoated or surface-sized paper. In addition to pulp fibres, the support paper may contain sizing agents such as alkyl ketene dimers, fatty acids and/or fatty acid salts, epoxidised fatty acid amides, alkenyl or alkyl succinic anhydride, starch, resin, wet-strength agents such as polyamine polyamide epichlorohydrin, dry-strength agents such as anionic, cationic or amphoteric polyamides, visual brighteners, pigments, dyes, anti-foaming agents and other chemical additives known in the paper industry. The raw paper may be surface-sized. Sizing agents suitable for this purpose are polyvinyl alcohol or oxidised starch, for example. The raw paper may be produced on a Fourdrinier paper machine or a Yankee paper machine (cylinder paper machine). The grammage of the raw paper may be from 30 to 200 g/m², in particular from 40 to 120 g/m². The raw paper may be used in compressed or non-compressed form (smoothed). Raw papers having a density of from 0.6 to 1.05 g/cm³, in particular from 0.70 to 0.9 g/cm³, are particularly suitable. The smoothing may take place in the usual manner by calendering.

For the paper production, all pulps commonly used for this purpose may be used. The pulp for the paper production is preferably a eucalyptus pulp having an amount of fibres smaller than 200 μm, after refining, of from 10 to 35 wt. % and an average fibre length of from 0.5 to 0.75 mm. It has been shown that the use of a pulp having a limited amount of fibres smaller than 200 μm reduces the loss in stiffness that occurs when filler is used.

Hardwood pulps (NBHK—northern bleached hardwood kraft pulp) and softwood pulps may also be used. In addition to pulp fibres, amounts of other natural or synthetic fibres may also be used for the production of the paper support. Preferably, the amount of the other fibres in the total fibre mass is lower than 40 wt. %; particularly preferably, amounts of other fibres are lower than 20 wt. %.

Kaolins, calcium carbonate in its natural form such as limestone, marmor or dolomite, precipitated calcium carbonate, calcium sulfate, barium sulfate, titanium dioxide, talcum, silica, aluminium oxide and mixtures thereof, for example, may be used in the raw base paper as fillers for the sheet production. Calcium carbonate having a particle size distribution in which at least 60% of the particles are smaller than 2 μm and at most 40% thereof are smaller than 1 μm is particularly preferred. In a particular embodiment of the invention, calcite is used that has a numerical particle size distribution in which approximately 25% of the particles have a particle size of less than 1 μm and approximately 85% of the particles have a particle size of less than 2 μm. According to another embodiment of the invention, a calcium carbonate may be used that has a numerical particle size distribution in which at least 70%, preferably at least 80%, of the particles are smaller than 2 μm and at most 70% of the particles are smaller than 1 μm.

One or more additional layers may be arranged between the paper support and the dye-absorbing layer and/or the barrier layer. Said layers are preferably layers containing a hydrophilic binder.

The dye-receiving layer, which is arranged on the side of the base paper to be printed on, is porous according to the invention. Said layer preferably contains inorganic pigment and binder. Inorganic pigments having an anionic, neutral or only weakly cationic surface, such as silica, calcium carbonate, kaolin, talcum, bentonite or aluminium oxides or aluminium oxide dihydrates are particularly preferred. However, finely particulate, polymeric compounds may also be contained, high-melting-point thermoplastic or thermosetting polymers being preferred. In another embodiment of the invention, the dye-absorbing layer may also contain a mixture of two or more pigments. The pigments preferably have an average particle size of from 100 nm to 30 μm, particularly preferably from 200 nm to 10 μm.

The dye-receiving layer preferably additionally contains a polymeric binder, preferably a hydrophilic polymeric binder. The binder may be a binder that is water-soluble or dispersed in water. Preferred binders are styrene copolymers, polyvinyl alcohol, starch, modified starch, polyvinyl acetate, acrylates or polyurethane dispersions. The mass ratio of pigment to binder is from 100:1 to 100:50, preferably from 100:40 to 100:2.

The dye-receiving layer is preferably applied by applying an aqueous coating slip to the paper support, it being possible to use any application method commonly used in the paper industry. Application by means of a blade, doctor blade, film press or curtain coater is particularly preferred.

The coating slip may contain other common additives such as a wetting agent, thickeners, rheological auxiliaries, dyes and optical brighteners. The application weight of the dye-receiving layer is preferably from 1 g/m² to 50 g/m², particularly preferably from 3 g/m² to 30 g/m². The air permeability of the dye-receiving layer, measured according to Bendtsen, is greater than 100 ml/min, preferably from 200 ml/min to 700 ml/min. The dye-receiving layer comprises pores that may comprise an average pore diameter of from 10 nm to 5 μm, preferably from 100 nm to 1.5 μm and particularly preferably from 500 nm to 1 μm. The pore diameter of porous dye-receiving layers may be determined by mercury porosimetry. The mercury porosimetry method for determining pore diameters is described, for example, in M. J. Mouraa, P. J. Ferreirab, M. M. Figueiredob: Mercury intrusion porosimetry in pulp and paper technology, Powder Technology, 160(2), p 61-66 (2005). For the purposes of the invention, the mercury porosimetry was carried out by means of the porosimeter PASCAL 440 from Porotec/Thermo Fisher Scientific in order to determine the pore size of the dye-receiving layer.

According to the invention, a barrier layer is arranged between the dye-absorbing layer and the paper support and/or on the rear side of the paper support. The barrier layer is distinguished by a low permeability to air and gases and to water vapour. The air permeability of the barrier layer, measured according to Bendtsen, is lower than 100 ml/min, preferably lower than 10 ml/min. The barrier layer preferably contains one or more polymeric compounds. In an embodiment of the invention, the barrier layer contains one or more thermoplastic polymers, thermoplastic polymers having a high melting point, such as polyester or polymethylpentene, being particularly preferred. In this embodiment, the barrier layer may be applied by means of the melt-extrusion coating method.

In a particularly preferred embodiment of the invention, the barrier layer is formed by applying an aqueous solution or an aqueous dispersion of one or more polymers that are water-soluble or dispersed in water. Preferred polymers are styrene copolymers, polyvinyl alcohols or polyvinyl acetate. In another preferred embodiment of the invention, the barrier layer contains polymers based on renewable raw materials, such as starch, modified starch and/or cellulose derivatives, for example carboxymethyl cellulose (CMC).

The application weight of the barrier layer is preferably from 1 g/m² to 40 g/m², particularly preferably from 2 g/m² to 20 g/m².

The transfer material according to the invention is suitable in particular for transferring a printed image to a surface selected from polyester fabric, polyester non-woven fabric, a surface coated with a polyester layer, or a polyester surface.

The following examples are used to further describe the invention.

### EXAMPLES

1. Production of a Support Paper

A eucalyptus pulp was used to produce the support paper. For refining, the pulp, as an approximately 5% aqueous suspension (thick stock), was refined to a degree of refining of 26° SR by means of a refiner. The concentration of the pulp fibres in the thin stock was 1 wt. %, based on the mass of the pulp suspension. Other additives were added to the thin stock, such as a neutral sizing agent, namely alkyl ketene dimer (AKD), in an amount of 0.23 wt. %, a wet-strength agent, namely polyamine polyamide epichlorohydrin resin (Kymene®), in an amount of 0.60 wt. %, starch (C-Bond HR 35845) in an amount of 1.0 wt. %, and a natural, refined CaCO₃ in an amount of 15 wt. %. The amounts specified are on the basis of the mass of the pulp.

The thin stock, the pH value of which was set to approximately 7.5, was brought onto the wire of the paper machine by the headbox; subsequently, while dewatering the web, the sheet formation took place in the wire section of the paper machine. In the press section, the paper web was further dewatered to a water content of 60 wt. %, based on the weight of the web. The further drying took place by means of heated drying cylinders in the dryer section of the paper machine. A raw paper having a grammage of 90 g/m², a filler content of 10 wt. % and a moisture content of approximately 5.5% was formed.

The raw paper is surface-sized with starch solution, containing 3 wt. % C-Film 05731 starch from Cargill, and with water, on both sides in a size press. The starch application on the two sides together is approximately 1.5 g/m². After the starch has been applied, the support paper is dried and smoothed again. The base paper thus obtained has an air permeability, measured according to the Bendtsen method according to DIN 53120-1, of 700 ml/min.

2. Production of a Coating Slip for the Dye-Receiving Layer

13 g of a precipitated silica (CP510 from Grace) and 134 g of an aqueous 10 wt. % solution of a fully saponified polyvinyl alcohol (Mowiol® 28-99 from Kuraray) are slowly added to 208 g of a diluted dispersion of precipitated calcium carbonate (Precarb® 724 from Schaefer Kalk) having a solids content of 45 wt. %, and the mixture is mixed by means of a dissolver agitator. 1.5 g of a wetting agent, Surfynol® 440 from Air Products, is then mixed in. The coating slip obtained has a solids content of 34 wt. % and a ph of from 7 to 8. The average pore diameter of a layer produced from this coating slip, measured by means of mercury porosimetry, is 750±50 nm.

3. Production of a Coating Slip for the Barrier Layer

4 g of a wetting agent, Surfynol® 440 from Air Products, is added to 1,000 g of an aqueous solution of 10 wt. % fully saponified polyvinyl alcohol (Mowiol® 28-99).

4. Comparative Material V1

A commercially available transfer material having a release and blocking layer (Transjet Classic 831-100 g/m²) is used as a comparative material. This comparative material does not have a porous coating on the printing side.

5. Production of a Transfer Paper not having a Barrier Layer (Comparison V2)

The coating slip from example 2 is applied, by means of a doctor blade, to the support paper produced according to example 1 and is dried. The dry application is 15 g/m².

6. Production of a Transfer Paper having a Barrier Layer between the Dye-Absorbing Layer and the Supportpaper (Invention E1)

The coating slip for the barrier layer from example 3 is applied, by means of a doctor blade, to the support paper from example 1 and is dried. The dry application was 5 g/m². Subsequently, the coating slip from example 2 is applied, by means of a doctor blade, to the barrier layer thus obtained and is dried. The dry application of this layer is 20 g/m².

7. Production of a Transfer Paper having a Dye-Absorbing Layer on the Front Side and a Barrier Layer E2 on the Rear Side of the Support Paper (Invention E2)

The coating slip from example 2 is applied, by means of a doctor blade, to the support paper produced in example 1 and is dried. The dry application is 15 g/m². The coating slip for the barrier layer from example 3 is applied, by means of a doctor blade, to the side of the support paper opposing the barrier layer thus obtained and is dried. The dry application was 5 g/m².

Testing Method

A colour image was printed on the transfer materials obtained, using the inkjet printer EPSON WP4015 together with sublimation colour inks SubliJet IQ from Sawgrass.

The drying after the inkjet printing was assessed using two testing methods:
a) Smearfastness test: after a defined time (fresh, 30 sec, 1 min, 3 min, 5 min), a finger was run over four solid-dye printed boxes in the colours cyan, magenta, yellow and black and the smearing of the colours was assessed.
b) Imprint test: the printed solid-dye surfaces CMYK are brought into direct contact with the rear side of a second sheet of the transfer material immediately after the printing and pressed by a 5 kg cylinder (Cobb cylinder).

Subsequently, a visual assessment is made as to how much dye has passed through to the rear side of the second sheet.

Transfer of the printed image to a textile fabric by sublimation:

In a transfer press, Rotex Autoswing X from Sefa, the image side of the printed-on transfer material is brought into contact with a polyester fabric, Berger-Backlight satin FR+w; a sheet of office copying paper having a grammage of 80 g/m² is additionally placed onto the rear side of the transfer material in order to assess the dye bleed-through. At a temperature of 200° C., a contact pressure at level 30 according to the level indicator scale of the press is exerted for 30 seconds. The fabric and the copying paper are then separated from the transfer material.

The printing sharpness is assessed visually and by means of a microscope, both on the transfer material before the image transfer and on the fabric after the sublimation transfer.

The dye density for the solid-dye boxes CMYK is measured by means of a spectrophotometer, SpectroEye from X-rite.

The dye bleed-through is visually assessed on the basis of the dye that was transferred to the copying paper, placed onto the rear side, during the sublimation transfer process.

TABLE
test results for V1, V2, E1 and E2.

| | V1 | V2 | E1 | E2 |
|---|---|---|---|---|
| Air permeability | <1 ml/min | 225 ml/min | <1 ml/min | <1 ml/min |
| (Bendtsen, DIN | | | | |
| 53120-1 edition | | | | |
| 1998-06) | | | | |
| Drying (average of | −−− | +++ | ++ | +++ |
| smearfastness and | | | | |
| imprint) | | | | |
| Printing line | +/+ | +++/+++ | ++/+ | +++/+++ |
| sharpness before | | | | |
| and after the | | | | |
| sublimation | | | | |
| transfer onto the | | | | |
| fabric | | | | |
| Transferred dye | +++ | ++ | +++ | ++ |
| density | | | | |
| Dye bleed-through | +++ | −− | ++ | +++ |

The test results in the table show that the transfer materials according to the invention have very good drying properties after inkjet printing, demonstrate high line sharpness, even in the image transferred to the fabric, transfer the sublimation dye to the fabric to a large degree during the sublimation transfer process, and release only very little dye through the rear side.

The pore size was determined by means of a porosimeter PASCAL 440 from Porotec/Thermo Fisher Scientific. Mercury was used as the pressure medium. The initial weight of the sample material was 1.0 g, the maximum pressure was 400 MPa, and the temperature was 22.7° C.

1. A transfer material for the dye-sublimation transfer method of an inkjet printed image, wherein the transfer material comprises a support and a dye-absorbing layer on the front side of the transfer material, characterised in that the dye-absorbing layer is porous, the porous dye-absorbing layer has an average pore diameter of from 10 nm to 5 pm and an air permeability, according to Bendtsen, of greater than 100 ml/min, and the transfer material contains a barrier layer with an air permeability, according to Bendtsen, of lower than 100 ml/min that is arranged either on the rear side of the transfer material or between the support and the porous dye-absorbing layer.

2. The transfer material according to claim 1, characterised in that the support is a paper support.

3. (canceled)

4. (canceled)

5. The transfer material according to claim 1, characterised in that the barrier layer is arranged on the side of the paper base facing away from the dye-absorbing layer.

6. The transfer material according to claim 1, characterised in that the barrier layer has an air permeability, according to Bendtsen, of lower than 50 ml/min.

7. The transfer material according to claim 1, characterised in that the surface of the dye-absorbing layer is anionically charged or neutral.

8. The transfer material according to claim 1, characterised in that the dye-absorbing layer has a pH of at least 7.0 on the surface.

9. The transfer material according to claim 1, characterised in that the dye-absorbing layer contains a pigment, selected from calcium carbonate, kaolin or silica.

10. The transfer material according to claim 1, characterised in that the barrier layer contains a water-soluble polymer.

11. The transfer material according to claim 10, characterised in that the water-soluble polymer is a polyvinyl alcohol, starch, modified starch or a cellulose derivative.

12. The transfer material according to claim 1, characterised in that the barrier layer has a grammage of from 2 g/m² to 20 g/m².

13. The transfer material according to claim 1, characterised in that the grammage of the dye-absorbing layer is from 3 g/m² to 30 g/m².

14. A method for transferring an image to a surface, characterised in that an image is printed on a transfer material according to claim 1 by means of the inkjet printing method and the image is transferred to the surface by sublimation.

15. The method according to claim 14, characterised in that the surface is selected from polyester fabric, polyester non-woven fabric, a surface coated with a polyester layer, or a polyester surface.
